(19) United States
(12) Patent Application Publication
(10) Pub. No.: US 2003/0165079 A1
(43) Pub. Date: Sep. 4, 2003

(54) Swirling-flow micro mixer and method

(76) Inventors: Kuan Chen, Salt Lake City, UT (US); Ampere Tseng, Tempe, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/317,405

(22) Filed: Dec. 11, 2002

Related U.S. Application Data
(60) Provisional application No. 60/339,230, filed on Dec. 11, 2001.

(51) Int. Cl. B01F 15/00; B01F 13/00

(52) U.S. Cl. 366/165.1; 366/173.1; 366/341

(57) ABSTRACT

A method and apparatus for efficiently and rapidly mixing liquids in a swirling flow micro system is disclosed. The micro mixer disclosed is a passive mixer of planar structure for simpler configuration and fabrication. The streams injected tangentially into the mixing chamber produce circular multi-lamination for effective mixing of the injected streams. The injection velocity and position can be altered by adjusting the contour and exit area of the nozzles. The planar mixer can be fabricated by the normal photolithography process in conjunction with anodic bonding. More economically the layered structures of the mixer can also be fabricated in thin plastic sheets using stamping, embossing or other thermal deformation techniques. The different layers are thermally bonded for mass production.

### CLAIM TO DOMESTIC PRIORITY

The present non-provisional patent application claims priority to provisional application serial No. 60/339,230, entitled “Swirling-flow Micro Mixer of Planer Structure,” filed on Dec. 11, 2001, by Kuan Chen et al.

### FIELD OF THE INVENTION

The present invention relates, in general, to mixing devices and, more particularly, to a swirling-flow micro mixer.

### BACKGROUND OF THE INVENTION

Mixing of fluids is frequently required in order to initiate a chemical reaction. Such chemical reactions are necessary, for example, in an analysis in which the presence and/or concentration of a species in a fluid is to be determined. For that purpose a reagent or several reagents, is added to a fluid which forms with the species a reaction product which can be detected in a detector or sensor. A controlled and homogeneous mixing of the fluid and the reagent, that is, between two or more fluids, is desirable.

Micro mixers are the main components of so-called micro reactors, which are capable of performing most of the tasks large chemical reactors can do but at reduced costs and sizes. Many physical, chemical, and biomedical sensors also require mixing of a fluid sample with other fluids. One of the major advantages of the micro reactor is that the required sample quantity is much less than their larger counterparts. Most micro mixers have a planar configuration so that they can be batch fabricated using the micro fabrication techniques originally developed for micro electronics as well as other fabrication methods such as stamping and embossing.

Mixing of two or more fluid streams is also encountered in other MicroElectroMechanical Systems (MEMS) devices such as micro valves, micro pumps, micro gas turbines, and micro instruments. In addition to their compactness and batch-fabrication capability, a great potential and advantage of the micro mixers is their extremely short mixing time, which is in the range of 1.0 seconds down to sub-milliseconds. This feature of a micro mixer is very important to the quench-flow method used to investigate protein folding and other fast chemical reactions. Although convective segmentation mechanisms are almost absent for flow in micro channels and microstructures, effective mixing can still be accomplished via diffusion if the flows are divided into a large number of alternating sub streams. The mixing process can be completed very rapidly if the flows are split into micron-sized substreams. This “multi-lamination” technique has been widely used in passive micro mixer designs for efficient mixing.

The major problem for micro mixers employing the multi-lamination design principle is that a large number of micro channels or micro nozzles are required to subdivide the main flows into multiple thin sheets. Sophisticated microfabrication techniques such as LIGA are often needed to fabricate the flow channels or nozzles. The yielding rate of the fabrication process is generally low and the fabrication costs are high. Inspection of a large number of micro nozzles or flow channels can be time-consuming. High friction loss is another concern if the channels are too small or high shear rates occur between the mixing streams. Active mixers, such as ultrasonic vibration or electro-kinetic induced recirculation, have been developed to enhance micro mixing. However, the design and manufacturing of micro mixers utilizing these methods are more complicated and expensive than passive mixers, which use geometrical constraints to enhance mixing. Besides, heat generation due to the energy input for active mixing may present a problem to temperature-sensitive fluids such as proteins and other biological samples.

Millimeter- to micron-sized mixers have attracted increasing research interest and attention in recent years due to the vital role they play in micro chemical and biological analyzers, sensors, and other MEMS devices. The multi-lamination principle, which involves splitting the streams to be mixed into many substreams prior to mixing, is commonly used for effective mixing in small mixers with little or no convective segmentation. Most of today's passive micro mixers utilize a large number of nozzles or separations to divide the flow streams to be mixed into many substreams, resulting in high pressure losses. In addition considerable friction loss may occur when the main streams are divided into micron-sized substreams. Design, fabrication and inspection of a mixer with many micro nozzles or flow channels are difficult, time consuming and costly.

### BRIEF DESCRIPTION OF THE DRAWINGS

FIG. 1 illustrates a cross sectional top view of a passive micro mixer;

FIG. 2 illustrates a multi-dimensional view of the micro mixer;

FIG. 3 illustrates a hidden multi-dimensional view of the micro mixer;

FIG. 4 illustrates an exploded view of the micro mixer;

FIG. 5 illustrates stream lines plots of the fluid flow pattern;

FIG. 6 illustrates an alternate design of the micro mixer; and

FIG. 7 illustrates yet another design of the micro mixer.

### DETAILED DESCRIPTION OF THE DRAWINGS

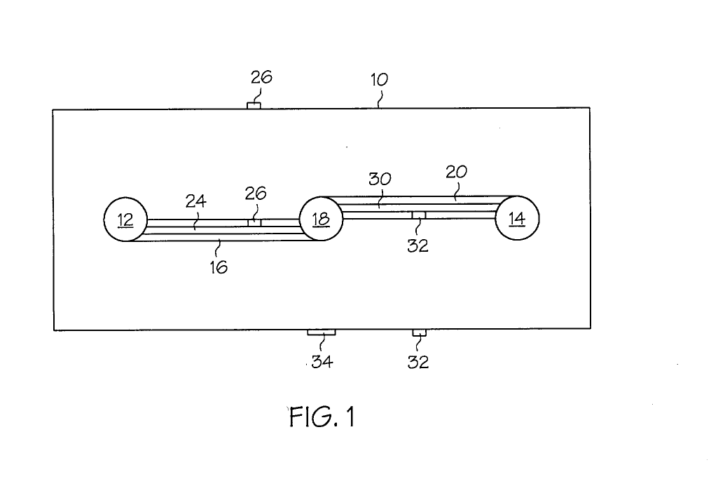

A cross-sectional top view of a passive micro mixer 10 is shown in FIG. 1 with a planar structure for mixing two or more gases or liquid streams. In mixer 10, a first fluid flows into inlet 12 and a second fluid flows into inlet 14. The first fluid flows through micro channel 16 and into mixing chamber 18. The second fluid flows through micro channel 20 and into mixing chamber 18. First and second pumps (not shown) force the first and second fluids into inlets 12 and 14, respectively. Alternatively, the first and second fluids can be gravity fed.

A channel arm 24 is adjustable with screw 26 to alter the channel width of micro channel 16. By turning screw 26, channel arm 24 moves to increase or decrease the channel width of micro channel 16. Increasing the channel width of micro channel 16 decreases the flow rate of the first fluid. Decreasing the channel width of micro channel 16 increases the flow rate of the first fluid.

Likewise, a channel arm 30 is adjustable with screw 32 to alter the channel width of micro channel 20. By turning screw 32, channel arm 30 moves to increase or decrease the channel width of micro channel 20. Increasing the channel width of micro channel 20 decreases the flow rate of the second fluid. Decreasing the channel width of micro channel 20 increases the flow rate of the second fluid.

Other mechanisms, such as paddles connected to the channel arms, can be used to move channel arms 24 and 30 to change the channel widths of micro channels 16 and 20 and the flow rates of the first and second fluids, respectively. Micro channels 16 and 20 are adjustable in a range from say 10 microns to 1 millimeter with a typical channel width of 100 microns. A typical flow rate for fluids is 1 cubic centimeter per minute and for gases is 1 liter per minute.

The first and second fluids flow into mixing chamber 18 where they are mixed together by a rotational or swirling action within the chamber. The adjustable feature of micro channels 16 and 20 effective form a nozzle at each inlet to mixing chamber 18. Mixing chamber 18 has a curved or rounded surface, i.e. circular or oval to cause the rotational or swirling action of the first and second fluids upon entry into the chamber. The nozzles of micro channels 16 and 20 are fashioned to follow the contour of the curved surface at the entrance to mixing chamber 18 as shown. The first and second fluids experience a minimal amount of turbulence by blending with the curvature of mixing chamber 18. The intensity of the swirling action is a function of the viscosity of the fluids and the flow rate as controlled by the nozzle outlets of micro channels 16 and 20. Following the mixing process, the mixture of the first and second fluids exits micro mixer 10 at outlet 34.

The swirling flow is induced with the nozzles on an axes tangential to the mixing chamber inlet. The streams injected tangentially into mixing chamber 18 produce circular multi-lamination for effective mixing of the first and second injected streams of gas or fluid. The injection velocity and position can be altered by adjusting the channel arms which in turn define the contour and exit area of the nozzles. Micro mixer 10 allows optimization of the rotation intensity with mixing chamber 18 and friction loss for different mixing conditions and fluids.

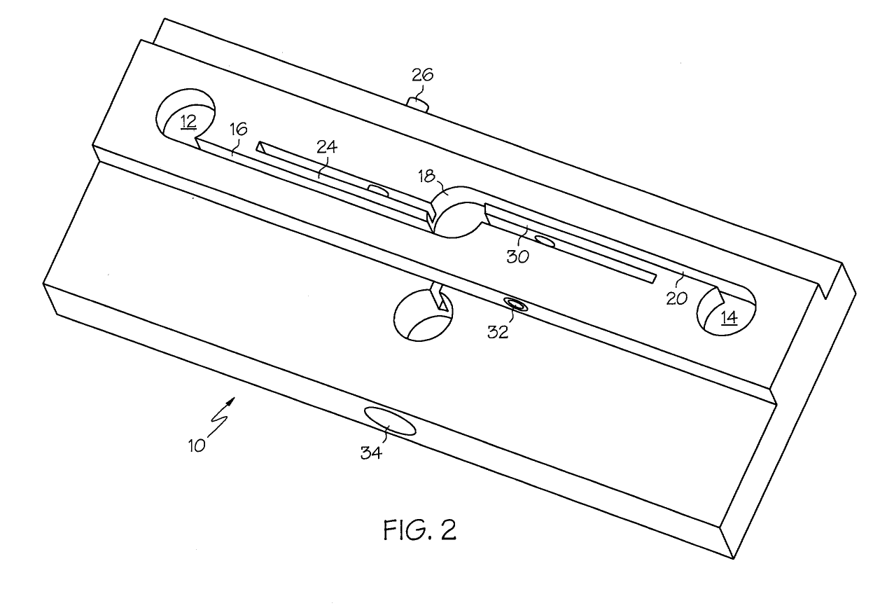

FIG. 2 is a multi-dimensional view of micro mixer 10. Components having a similar function are assigned the same reference numbers used in FIG. 1. FIG. 2 provides additional structural detail of the construction of micro mixer 10. In a similar manner, the fluids to be mixed are tangentially injected into mixing chamber 18 by the nozzles formed by micro channels 16 and 20. Rotation intensity of the swirling flow can be adjusted by varying the nozzle contour.

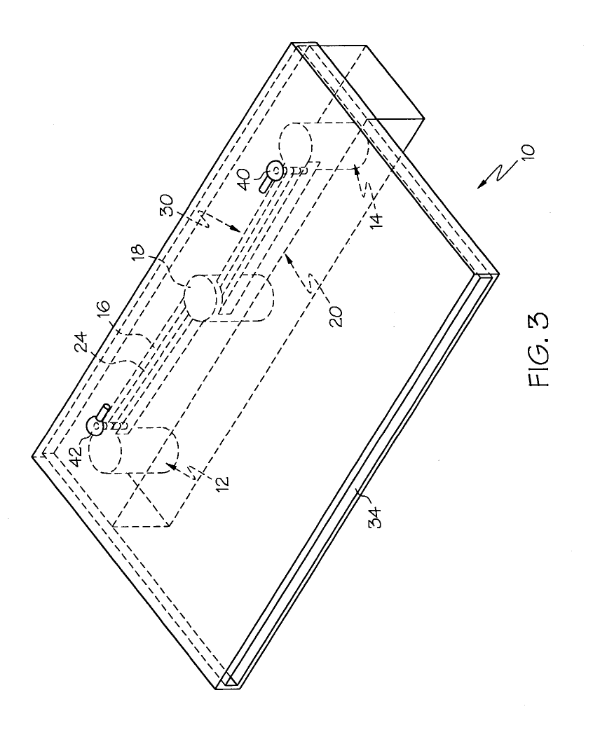

The design and mechanism for altering the nozzle contour can be seen more clearly hidden feature view in FIG. 3. Here, paddles 40 and 42 are shown as an alternate mechanism to control the channel width, i.e. the nozzle contour, of micro channel 16 and 20, respectively. Paddles 40 and 42 are connected to channel arms 24 and 30, respectively. Rotating paddles 40 and 42 cause channel arms 24 and 30 to move and the channel width (nozzle area) of micro channels 16 and 20 to increase and decrease accordingly.

The higher outlet velocity for a smaller nozzle exit together with the larger radius at which the exit stream is injected into mixing chamber 18 results in a larger angular momentum of the swirling flow. A swirling flow of high angular momentum can yield effective mixing in a small chamber, but the friction loss of the nozzle may be high. Conversely if only moderate rotation intensity is needed for mixing, the nozzle exit area can be adjusted larger to reduce the friction loss.

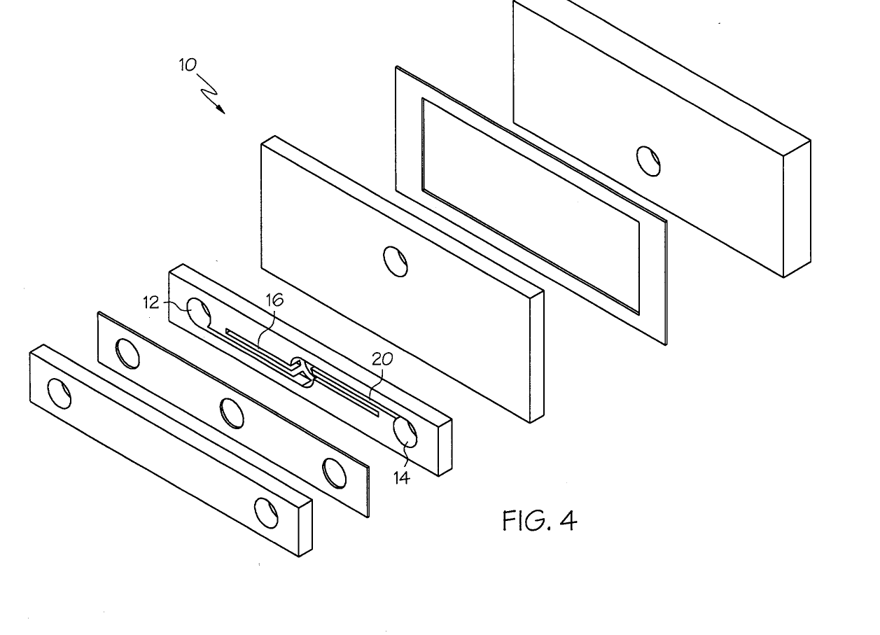

Turning to FIG. 4, an exploded view of the components of micro mixer 10 is shown. The base body of micro mixer 10 can be made by either silicon or other substrate material, including glasses, quartz, plastics, or any other material that does not react with the fluid.

Micro channels 16 and 20 and openings are made in this base body. These channels are hermetically sealed by silicon or glass substrates. The mixing element is in this case formed by a recess into which the two inlet channels open from opposite sides. Two part-flows are then extracted from this recess and are later mixed in the same manner in a following mixing element. The mixer can be fabricated by the normal photolithography process in conjunction with anodic bonding. More economically the layered structures of the mixer can also be fabricated in thin plastic sheets using stamping, embossing or other thermal deformation techniques. The different layers are then thermally bonded for mass production.

The simple design and configuration of swirling-flow micro mixer 10 makes it suitable for batch fabrication at low costs. Drastic reduction in the number of nozzles or flow channels as compared to the prior art reduces the fabrication costs and complexity. It also decreases the friction loss. Consequently the required pressure difference and pumping power are lower in comparison with conventional passive micro mixers. Since the nozzle contour and exit area are adjustable, the angular momentum and friction loss of the swirling flow can be optimized for different mixing conditions and fluids.

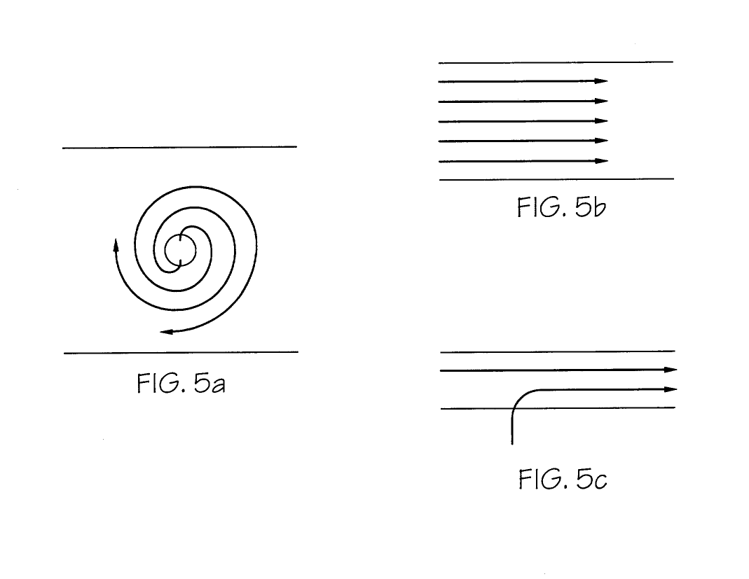

The mixer design adopts a multi-lamination concept to enhance mixing in microscale flows. However, unlike other micro mixer designs, multi-lamination in micro mixer 10 is generated by a swirling flow as the flow is rotating in mixing chamber 18 as shown in the stream line plot of FIG. 5(a). The differences of the two methods for multi-lamination generation can be clearly seen in the other streamline plots of FIG. 5. Since the desired swirling flow can be generated by a pair of nozzles with their axes tangent to the mixing chamber inlet, fabrication of the swirling-flow mixer 10 is expected to be much simpler and less expensive than the lateral or vertical mixing designs, (see FIGS. 5(b) and 5(c)) which involve a large number of straight laminar sheets. At high flow velocities, the centrifugal force at small radii (where the two streams are injected into the planar mixing chamber) may provide an additional mixing mechanism and secondary flows or turbulence could be induced for enhanced mixing in the radial direction.

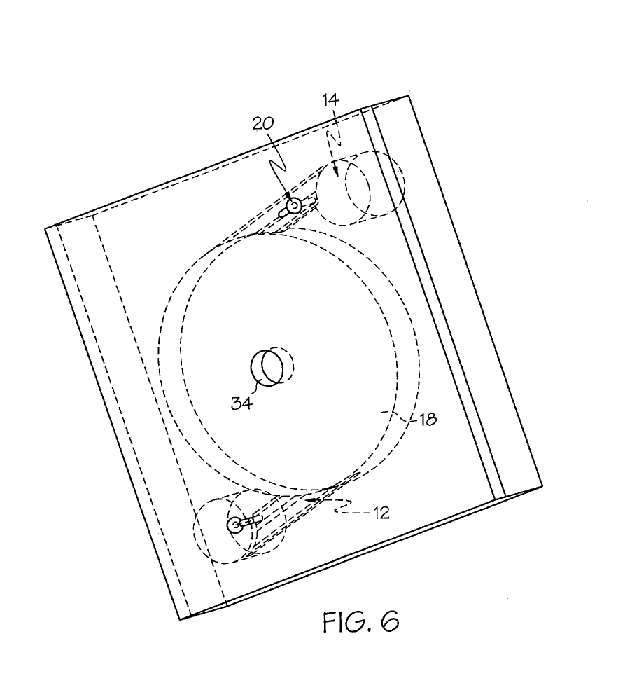

An alternative mixer design to generate the laminated swirling flow is shown in FIG. 6. The streams to be mixed are injected tangentially into a circular chamber from its rim. As the two or more fluid streams entering from different circumferential positions flow toward the exit port located at the center of the circular chamber, multi lamination can be generated automatically due to the rotation of the injected streams. In this design the nozzles and the mixing chamber can be fabricated in the same layer. As a result fabrication and packaging of this mixer design are much easier and less expensive. This mixer design is anticipated to work well with deep mixing chambers.

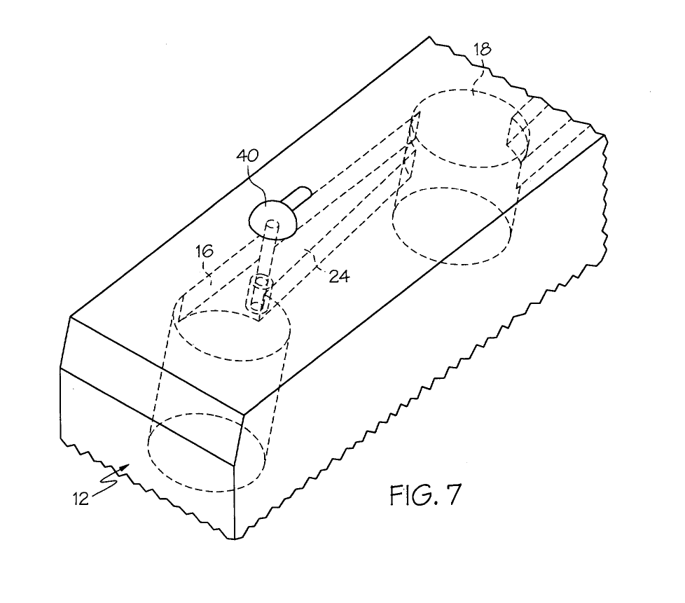

However, for shallow chambers the high friction loss may considerably reduce the angular momentum of the injected streams before they are wrapped into a laminated vortex, and effective mixing may need more time or longer channel to be achieved. Another aspect of this design is the local secondary flows and turbulence spots generated by the strong centrifugal force at small radii may be less likely to occur if fluids are injected at the maximum radius. If these difficulties occur, the design and mechanism shown in FIG. 7 can be employed to alter the nozzle contour and exit area for both injection arrangements.

Mixer 10 is especially useful in applications where fluids are resistant to movement, e.g. chemical, biochemical, biomedical, and biological sensing and analyzing systems have been commercialized and commonly used for medical, environmental, and military applications. For example, micro mixer 10 can be used for drug delivery and DNA synthesis. If the fluid do not flow freely, there can be no effective mixing action. The rounded surface of mixing chamber 18 and its contour with the nozzle action of micro channels 16 and 20 provides the mechanism to achieve a good mixture of the first and second fluids. Mixing of two or more fluids is often required in these micro sensors or analyzers.

The passive design of micro mixer 10 costs less to fabricate, consumes less energy and is easier to operate in comparison with active micro mixers. The swirling flow design allows multi-lamination to be generated by means of simple geometrical constraints and/or flow arrangement. The size of the mixer thus can be reduced; the fabrication costs and time decreased, and the friction loss improved.

Another important application of the micro mixer is the effective mixing of oxidizer and fuel in micro heat engines, which can be batch fabricated in silicon wafers or other substrates. Micro mixer 10 can simplify the engine design and can result in efficient combustion without considerable pressure losses and the need of a large mixing/combustion chamber. The variable-nozzle design enables optimal mixing for different fluids and different flow rates.

What is claimed is:

1. A micro mixer, comprising:
a chamber having a rounded inner surface; and
first and second nozzles, coupled to first and second inlets of the chamber for injecting first and second streams, respectively, into the chamber and causing rotation of the first and second streams to produce a mixture of the first and second streams within the chamber.

2. A method of mixing first and second streams in a micro mixer, comprising:
injecting the first stream through a first nozzle into a chamber having a rounded inner surface; and
injecting the second stream through a second nozzle into the chamber to cause a rotation of the first and second streams to produce a mixture of the first and second streams within the chamber.
